(19) United States
(12) Patent Application Publication
(10) Pub. No.: US 2011/0084026 A1
(43) Pub. Date: Apr. 14, 2011

(54) Biomimetic membranes, their production and uses thereof in water purification

(75) Inventors: Viatcheslav Freger, Beer-Sheva (IL); Amir Berman, Omer (IL); Yair Kaufman, Beer-Sheva (IL)

(73) Assignee: B.G. Negev Technologies Ltd., Beer-Sheva (IL)

(21) Appl. No.: 12/801,874

(22) Filed: Jun. 29, 2010

Related U.S. Application Data
(60) Provisional application No. 61/213,650, filed on Jun. 30, 2009.

(51) Int. Cl. C02F 1/44; B01D 71/74; B01D 71/06; B05D 5/00

(52) U.S. Cl. 210/653; 210/321.6; 210/500.27; 427/244

(57) ABSTRACT

The present invention discloses a water membrane comprising a lipid bilayer supported on a single side thereof on a water permeable dense support layer, this lipid bilayer being composed of one or more lipids and aquaporin proteins are embedded therein, further wherein the water permeable dense support layer is impermeable to the lipids and to the aquaporin proteins. Also are provided a method for the preparation of these membranes and uses thereof in water filtration applications.

### CROSS REFERENCE TO RELATED APPLICATIONS

This application is based upon and claims the benefit of priority from the prior U.S. Provisional Patent Application Ser. No. 61/213,650, filed on Jun. 30, 2009, the entire content of which is incorporated herein by reference.

### FIELD OF THE INVENTION

The present invention discloses novel water membranes which comprise a lipid bilayer with incorporated aquaporins, on a dense water-permeable support layer. In particular, the invention pertains to water membranes in which the lipid/aquaporin bilayer is supported on a nanofiltration (NF) membrane or a reverse-osmosis (RO) membrane serving as the dense water-permeable support layer. The invention also discloses methods of preparation of such membranes and their use in water filtration.

### BACKGROUND OF THE INVENTION

Presently, the most economic way to filtrate water is by the process of reverse osmosis (RO) or nanofiltration (NF), whereby water is selectively passed through semi-permeable membranes using mechanical pressure as a driving force.

Pressure driven membranes processes are classified according to the following categories: microfiltration, ultrafiltration (UF), nanofiltration (NF) and reverse osmosis (RO). Microfiltration and ultrafiltration membranes are characterized by a well-defined structure, with pore size ranging between 0.1 and 10 μm and 1 and 100 nm, respectively. The functional layers in nanofiltration and reverse osmosis membranes are made of a dense polymeric layer that allows water permeation via interstitial, intermolecular passages with “effective-pore” sizes in the range of angstroms. The passage of filtrate through nanofiltration and reverse osmosis membranes is accomplished through the spaces between the polymer chains or within a polymer network forming the dense polymer film of which the membrane is composed.

The composite membrane for NF and RO generally comprises two or three distinct layers. The active top layer is 10 to 1000 nm thick and is dense, non-porous and provides the separation selectivity. The top layer is usually placed on an asymmetric, 10 to 1000 micron thick porous layer that provides the mechanical strength and has a low hydraulic resistance to permeate flow. In most commercial membranes a second supporting layer, made of a non-woven polymer fabric, further reinforces the membrane construct. The active top layer is usually produced using interfacial polymerization and is composed of polyamide or polyurea polymer, sometimes with an additional layer of polyvinyl alcohol or other polymers. Other important methods for preparing the composite membranes include coating and plasma polymerization. The porous second layer is made of polysulfone, polyethersulfone, polyacrylonitrile and other polymers by phase inversion method (solution precipitation). Another type of composite RO and NF membranes, which differs from the multilayer composites described above, is integrally-skinned membrane, in which both the dense top and porous supporting layers are formed from one polymer (e.g., cellulose acetate) in one manufacturing step by phase inversion. The structures of the composite and integrally-skinned NF and RO membranes set forth above and methods for manufacturing the same are described, for example, in M. Mulder, Basic Principles of Membrane Technology; Kluwer Academic Publishers: Dordrecht, The Netherlands, 1991.

Aquaporin is a universal water-channel membrane protein, present in all living cells, which enables cells to regulate their water balance. While aquaporins are a group of proteins that transport pure H₂O molecules, some aquaporin varieties also pass glycerol and other specific small solute molecules. Apart from complete rejection of ions, aquaporins selectively reject solutes such as urea that readily pass polymeric membranes (M. L. Zeidel, S. V. Ambudkar, B. L. Smith, P. Agre, Biochemistry 1992, 31, 7436). Aquaporins can pass water at a very high rate; for example, a report has shown that the osmotic water permeability of single channel is in the range of 6×10⁻¹⁴ to 24×10⁻¹⁴ cm³/s (B. Yang, A. S. Verkman, Journal of Biological Chemistry 1997, 272, 16140).

It should be stressed that normally, biological membranes are held together by van der Waals forces and are typically unable to withstand pressure gradients necessary for RO membranes, quite in contrast to polymeric membranes which are much stronger. Thus, free-standing, unsupported, biological membranes and their equivalents run the risk of collapse and loss of material while used for filtration.

One solution employed in commercial polymeric RO membranes is to support the selective thin film with a mechanically robust and water permeable film. Numerous published reports demonstrate the feasibility of preparing supported lipid bilayer (SLB) or supported phospholipid bilayers (SPB) mimicking biological membranes on solid substrates (see for example, R. Rapuano, A. M. Carmona-Ribeiro, Journal of Colloid and Interface Science 2000, 226, 299). However, these substrates are impermeable to water and hence are unsuitable for water filtration.

United States Patent Application 20090120874 (to Aquaporin Inc.) discloses a SPB based on a porous solid substrate, onto which lipids and aquaporins are assembled by vesicle fusion. The authors specifically and deliberately designed these supports to have pores typically in the 10-40 nm range so as to achieve the required filtration through, but their porous membrane provided a weak support, unsuitable for activity under moderate to high hydraulic pressures, i.e., well in excess of 1 bar (14.5 psi), under which the free standing bilayer will collapse.

There therefore remains a challenge to provide novel biomimetic membranes with embedded aquaporin water channels, which will be effective for water filtration under moderate to high hydraulic pressures.

### SUMMARY OF THE INVENTION

It has now been proposed that devising a water permeable support with a dense, i.e., non-porous surface may provide a strong yet effective water filtration membrane, thereby preventing the collapse of the bilayer under hydraulic pressure and loss of lipid and protein components with water flow and facilitating water filtration through the aquaporin proteins molecules.

In particular, the inventors have now devised a novel nano-biotechnological water membrane comprising a lipid bilayer with incorporated aquaporins, supported by an NF membrane that is especially suitable for selective water filtration. Thus, while a lipid bilayer or a phospholipid bilayer in itself might be vulnerable when using hydraulic pressure, the NF support provides it with improved physical stability.

Furthermore, unlike porous supports, the present dense support is impermeable to lipids and/or proteins, and will also fully prevent their gradual loss with water flow.

Yet further, given these advantages, no extra protective layer is necessary above the bilayer, as proposed in the art (see US application No. 20090120874), which will minimize concentration polarization at the upstream side, associated with such a sandwich structure.

Thus, according to one aspect of the present invention, there is provided a water membrane comprising a lipid bilayer supported on a single side thereof on a water permeable dense support layer, wherein

the lipid bilayer is composed of one or more lipids, wherein aquaporin proteins are embedded in the one or more lipids,

and further wherein the water permeable dense support layer is impermeable to the one or more lipids and to the aquaporin proteins.

According to another aspect of the present invention, there is also provided a procedure for preparing these dense-supported lipid or phospholipid bilayers with embedded aquaporins.

According to yet another aspect of the present invention, there is also provided a use of the membranes described herein for filtration, water desalination, water recycling, water purification and/or energy production.

The corresponding water filtering devices are also provided.

### BRIEF DESCRIPTION OF THE DRAWINGS

FIG. 1 is a series of fluorescence microscopy images of NF270 and NTR7450 membranes covered by DMPC and 0.5% Rh-PE using vesicle fusion at different pH; The solutions contained no salts except for NaOH and HCl used to adjust pH;

FIG. 2 is a series of AFM topography images scanned using liquid tapping mode, whereas (A) is a clean surface of NTR7450 membrane and (B) is the surface of a treated NTR7450 membrane after 40 minutes of vesicle fusion and (C) is the surface of a treated NTR7450 membrane after 120 minutes of vesicle fusion;

FIG. 3 is a diagram showing hydraulic permeability measurements of a clean NTR7450 membrane, and of a NTR7450 membrane after 3 hours of vesicle fusion;

FIG. 4 is a the ATR-FTIR spectra of a clean NTR7450 membrane (bright line) and a NTR7450 membrane covered with lipids (darker line);

FIG. 5 is a diagram showing the permeability and urea rejection of an NTR7450 membrane with and without SPB with embedded aquaporins; and

FIG. 6 shows a scheme of a typical membrane structure, according to preferred embodiments of the invention.

### DETAILED DESCRIPTION OF THE INVENTION

As Explained in the background section above, there remains a challenge to provide novel biomimetic membranes with embedded aquaporin water channels, which will be effective for water filtration under moderate to high hydraulic pressures.

The inventors have now successfully designed and tested novel membranes which are suitable for selective water filtration, and are based on lipid bilayers embedded with aquaporin proteins, which are supported on dense water-permeable membranes.

Therefore, according to one aspect of the invention, there is provided a water membrane comprising a lipid bilayer supported on a single side thereof on a water permeable dense support layer, wherein

the lipid bilayer is composed of one or more lipids, wherein aquaporin proteins are embedded in these one or more lipids,

and further wherein the water permeable dense support layer is impermeable to the one or more lipids and to the aquaporin proteins.

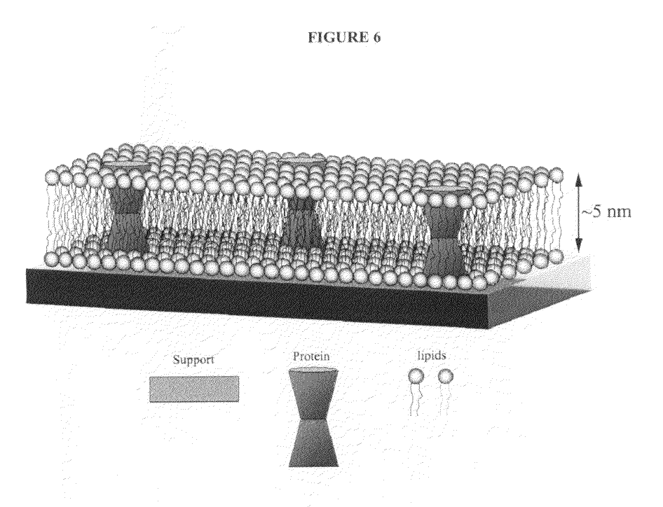

FIG. 6 shows a scheme of a typical membrane structure, according to preferred embodiments of the invention.

The term “water membrane” as used herein refers to a structure which allows the passage of water, whereas most other materials or substances are not allowed passage at the same time. Preferred water membranes of the invention are essentially only permeable for water and much less so to salts and organics molecules, such as lipids and proteins. It should be emphasized that the SLB itself (without the embedded aquaporins) is almost completely water impermeable.

The term “supported” as used herein refers to mechanical support where attachment between the SLB and the NF or RO membranes is provided by “non specific forces”, i.e. there is no specific molecular site in the biomimetic membrane that connects to the support. The forces may include electrostatic forces and polar interaction forces and the two interfacial planes are of compatible hydrophilicity and electrostatic charge.

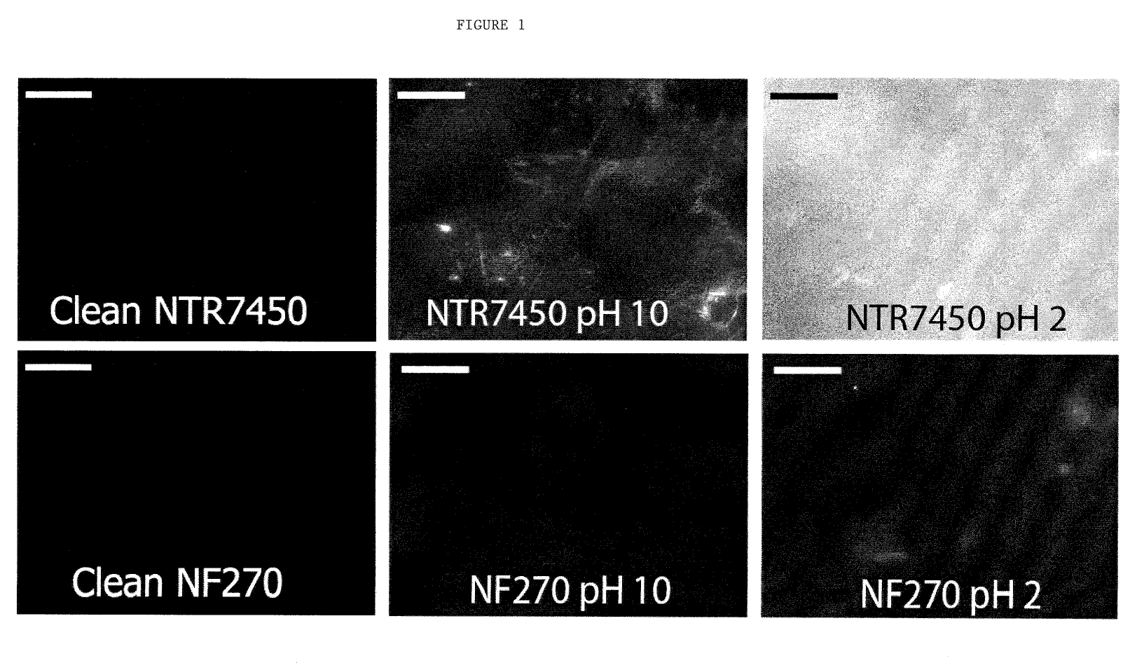

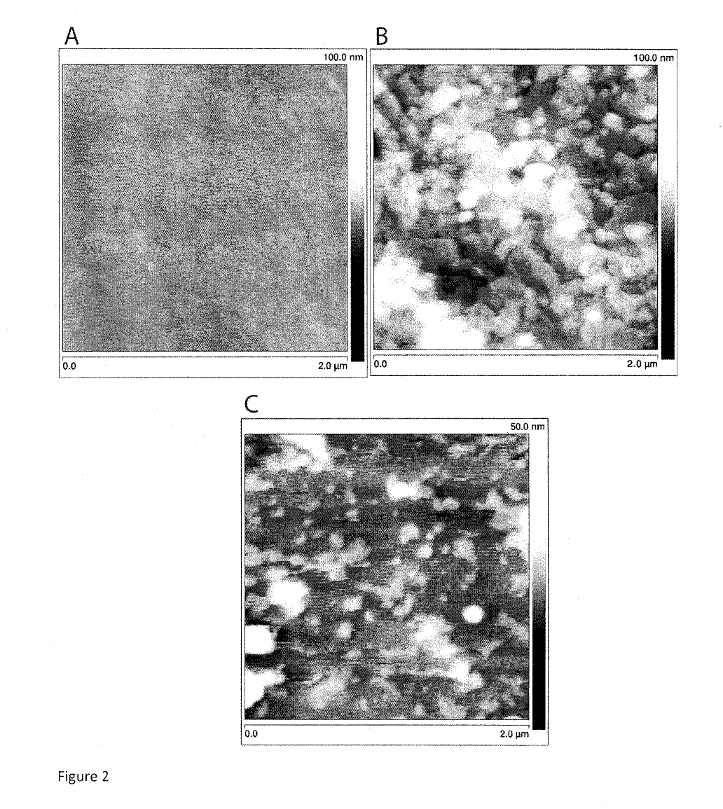

One way to confirm that the bilayer is indeed supported is by fluorescence microscopic (FM) observation (as is indeed shown in FIG. 1) or by scanning force microscopy (SFM) (as is indeed shown in FIG. 2). FM requires the addition of 0.5%-2% of fluorescent probe to enable analysis. SFM analysis provides a direct surface analysis which is capable of verifying the presence and coherence of the SPB.

The terms “dense support layer” is used interchangeably with the term “non-porous membrane”, and refers to a membrane which has a dense or “non-porous” outer surface. This structure is known by a man skilled in the art to designate membranes having at least one layer being substantially nonporous, i.e., not having any permanent and deliberately made pores or porous structure. This definition explicitly excludes intermolecular free space inherently existing in non-porous solid or polymeric materials and often filled with solvent, if the solid or polymer takes up a solvent and swells in it, due to which these dense materials may be permeable to certain small molecules despite absence of permanent pores.

Thus, as used herein, the terms “nonporous membrane” or “dense membrane”, include membranes which are at the same time impermeable to lipids and/or proteins but are permeable to water. These membranes may also be impermeable to other organic compounds.

According to preferred embodiments of the invention, the membranes described herein have a support layer which is composed of a dense nonporous polymeric substrate.

The term “polymeric substrate” means substances composed of either a specific monomeric constituent or a limited variety of defined monomeric constituents covalently linked together or condensed in a linear or crosslinked structure.

The term “dense polymeric substrate” refers to polymers which are either crosslinked or not, and form a homogenous non-porous structure with effective pore size of molecular dimensions, i.e., <2 nm.

In a preferred embodiment of the invention, the dense support or dense polymeric substrate is a nano-filtration (NF) membrane.

In another preferred embodiment of the invention, the dense support or dense polymeric substrate is a reverse-osmosis (RO) membrane, optionally combined with a NF membrane.

This includes nano-filtration (NF) membranes and reverse-osmosis (RO) membranes which are composed of a polymer which is selected from, inter alia, polyamide, polyethers and sulfonated polyether-sulfones. It is known that such membranes, having the dense support layer, shall withstand high hydraulic pressures.

The term “lipid bilayer” refers to the arrangement of amphiphiles having a hydrophilic “head” group attached via various linkages to a hydrophobic “tail” group. In an aqueous environment, the amphiphiles form a layer of two molecules in which the hydrophobic “tails” are directed to the inside of the bilayer(s) while the hydrophilic “heads” are directed to the outside of the bilayer(s), on both sides of the membrane.

In a preferred embodiment, the lipid in the lipid bilayer is a phospholipid, and therefore the lipid bilayer can be referred to as a “phospholipid bilayer”. In this case the “supported lipid bilayer” (SLB) is indeed a “supported phospholipid bilayer” (SPB).

In yet another a preferred embodiment, the phospholipid bilayer essentially consists of one or more phospholipids.

In particular, these one or more phospholipids may include, but are not limited to, 1,2-dimyristoyl-sn-glycero-3-phosphocholine (DMPC), 1,2-dimyrystoyl-3-trimethylammonium-propane (DMTAP), 1,2-dimyristoyl-sn-glycero-phosphoethanolamine-N-(Lissamine-Rhodamine B Sulfonyl) (Ammonium salt), DPPC, phosphoglycerides, sphingolipids, and cardiolipin, or mixtures thereof, for example with cholesterol as a minor constituent. It may also include artificial lipids and/or mixtures thereof.

Particular useful lipids and phospholipids for the formation of phospholipid bilayers to be used in the water membranes of the invention are known to those skilled in the art.

It should be clarified that the lipid bilayer, or the phospholipid bilayer, are supported only on one side thereof by the dense water-permeable membrane described hereinabove.

This means that when used for water filtration, the lipid bilayer is located up-stream and the dense support layer is located down-stream, so that the water to be filtered first passes through the bilayer embedded with the aquaporins.

This feature, namely that the bilayer is not supported on both sides thereof is advantageous in that it minimizes concentration polarization effects at the upstream side, associated with sandwich structures (where both sides of the bilayer are supported).

The aquaporin proteins are embedded in the lipid bilayer during preparation, e.g., via vesicle fusion.

The term “embedded in” is used interchangeably with the term “incorporated in” and refers to the proteins having compatible hydrophobic and hydrophilic interactions with hydrophobic core and hydrophilic exterior interactions, of the lipid bilayer, respectively. This interaction is therefore similar to that in biological lipid membranes.

Useful aquaporins for the preparation of water membranes according to the invention are: AQP1, TIP, PIP, NIP, and mixtures thereof. Additional useful aquaporins may include mutated AQP strains with increased salt and temperature stability, and performance properties such as “always open” pores.

The aquaporin family of membrane proteins as used herein include also the GLpF proteins which in addition to water molecules also pass glycerol.

The present invention is also believed to be applicable to membranes for other purposes, where other transmembrane proteins than aquaporins are incorporated in membranes.

Transmembrane proteins different from aquaporins suitable for inclusion in the membranes for the present invention are for instance selected from, but not limited to, any transmembrane protein found in the Transporter Classification Database (TCDB). TCDB is accessible at http://www.tcdb.org.

The membranes of the invention disclosed below will only pass water, thus facilitating water purification and filtration, desalinization, and molecular concentration through reverse osmosis.

The aquaporins are known to prevent the passage of all contaminants, including bacteria, viruses, minerals, proteins, DNA, salts, detergents, dissolved gases, and even protons from an aqueous solution, but aquaporin molecules are able to transport water because of their structure. The related family of aquaglyceroporins (GLPF) are in addition able to transport glycerol.

It should be noted that due to the special structure of the novel membranes of the present invention, the support layer is impermeable to the lipids and/or proteins (aquaporins) comprising the bilayer. Thus, in contrast to presently known membranes using porous support layers, the present membranes are not likely to suffer from the gradual loss of lipids and/or proteins by being washed through the membrane under the real-life conditions of moderate to high hydraulic pressure, quite unlike porous supports.

The term “impermeable” refers to rejection of free lipids or free proteins of over 99%.

Therefore the present membranes are more reliable and are more likely to operate well under filtration, desalination and recycling conditions.

According to a preferred embodiment of the invention, the molar ratio of the lipids to the aquaporin proteins (LPR) in the lipid bilayer ranges from 5000:1 to 50:1. More preferably, the LPR ranges from 200:1 to 50:1.

LPR stands for the number of lipid molecules relative to the number of protein molecules. Typical surface areas for lipid (L) A_{L}=0.5 nm² and the aquaporin protein (P) A_{L}=64 nm² (8 nm)² are very different. Employing a rough estimate, for a protein to be completely surrounded by lipid molecules their combined area can be estimated as (8 nm+2*0.5 nm)² yielding A_{(L+P)}=81 nm². The surface fraction occupied by the lipids is (81−64)/81=17/810.2. Hence per one protein molecule, there are 17 nm²/0.5 nm²*molecule⁻¹=34 lipid molecule, (LPR=34). This figure is doubled to account for bilayer organization, yielding LPR=64. At high surface density organization it may be expected that only one row of lipid molecules will separate neighboring proteins, hence the figure of LPR=50 is an approximate limit.

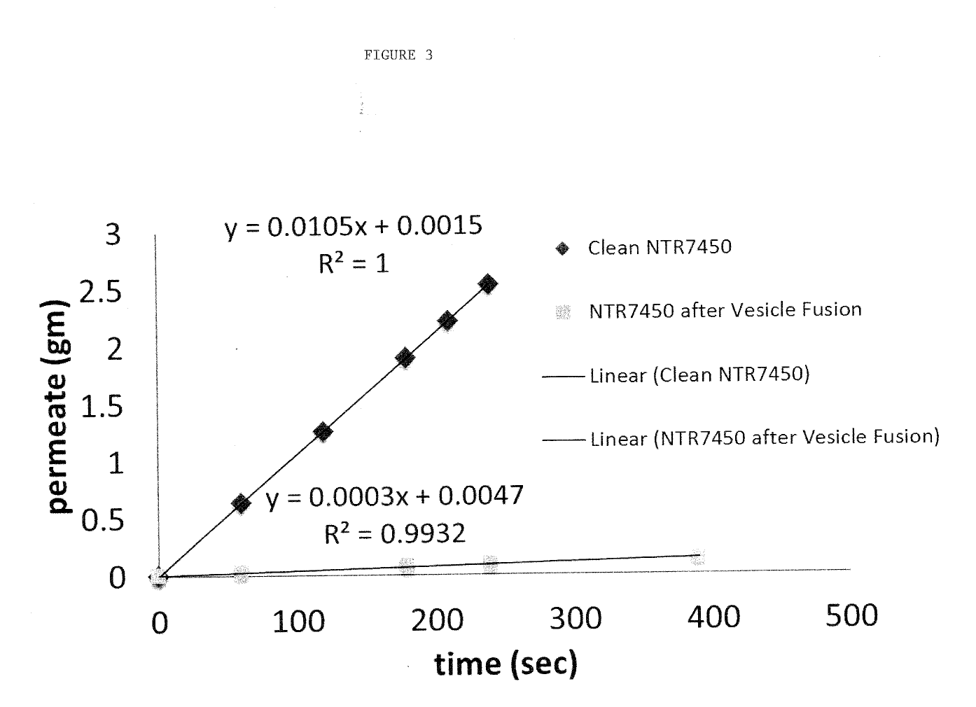

As shown in the experimental section below and in the Figures, the membranes of the present invention having the dense support layer, withstood hydraulic pressures of 290 psi and higher (as shown in FIG. 3), quite unlike presently-known biomimetic membranes.

Various procedures are commonly used for preparing supported lipid bilayers. A simple technique is the Langmuir-Blodgett (LB) method. A solution of lipid in a suitable organic solvent is spread on an aqueous sub phase in a Langmuir trough and the organic solvent is evaporated. A pair of movable barriers is used to compress the lipid film laterally to a desired surface pressure. Then the substrate is transferred vertically onto the substrate, thereby transferring a one molecule thick lipid layer (monolayer). A second monolayer can be transferred by passing the substrate through the film once more. A total of two monolayers can be deposited by the vertical Langmuir-Blodgett (LB) deposition method: first monolayer is transferred in the upstroke, followed by a downstroke movement. The supported assembly is then released into a container placed in the subphase and is kept wet until use.

A different method is the horizontal transfer method called Langmuir-Schaeffer (LS) deposition. In order to deposit a bilayer, LS may be used in conjunction with LB, where the first monolayer is deposited by LB, and the second is added by LS. In this manner bilayers with distinct asymmetry can be produced.

Both of these methods can be used with a variety of lipids. Native biological membranes often are asymmetric. Both LB and LS offer the possibility of preparing asymmetric bilayers. This is done by exchanging the lipid film on the sub phase between depositions, or as described herein by alternate LB-LS deposition. [Langmuir-Blodgett Films: An Introduction. Michael C. Petty, Cambridge University Press, 1996.]

Another way of preparing supported bilayers is the vesicle fusion method (Brian and McConnell 1984). A solution of small unilamellar vesicles (SUVs) is applied onto the surface. When this sample is left at low temperature (4° C.) the vesicles fuse with the surface to make a continuous bilayer. Without being bound to any theory it has been hypothesized that the vesicles first adsorb to the surface of the substrate then fuse to make a flat, pancake-like structure and finally rupture and spread out resulting in a single bilayer on the surface (Reviakine and Brisson 2000). It has also been suggested that after fusion with the substrate only the part of the vesicle which is in direct contact with the substrate becomes the supported bilayer (Leonenko et al. 2000). With this mechanism the vesicle ruptures at the edges with the highest curvature and the top part of the bilayer may then migrate to the surface of the substrate to increase the size of the formed supported bilayer. It has been reported that bilayers are formed within minutes of applying the solution onto the substrate (Tokumasu et al. 2003) but this short incubation time may result in incomplete bilayers. Hours or overnight incubation have also been reported (Reimhult et al. 2003, Rinia et al. 2000).

A third technique which can be used to prepare supported bilayers is spin-coating (Reimhult et al. 2003, Simonsen and Bagatolli 2004). In spin-coating the lipid is dissolved in a suitable solvent and a droplet is placed on the substrate which is then rotated while the solvent evaporates and a lipid coating is produced. Depending on the concentration of the lipid solution the spin-coated film consist of one or more phospholipid bilayers. However, upon hydration the multiple layers have been shown to be unstable, and usually only one supported bilayer remains on the surface. This procedure is easy and fast and it has been done with low-melting temperature lipids (POPC) as well as lipids with intermediate (DPPC) and very high transition temperature (ceramide). Useful lipids include, e.g., phospholipids and other lipids.

In order to incorporate peptides and proteins into the supported bilayers, vesicle fusion technique is the most applicable, since the other procedures mentioned involve solubilization of the proteins or peptides in organic solvents which are harmful to the proteins. Many membrane proteins may denature in organic solvents especially if they contain large domains exposed to the aqueous solution on either side of the membrane. It is therefore preferred to insert the peptides or proteins in vesicles. Many peptides and proteins such as aquaporins can be co-solubilized with lipid in the organic solvent prior to formation of vesicles and the peptide containing vesicles are then applied to the substrate. This has been done with a number of peptides, for example WALP (Rinia et al. 2000), gramicidin (Mou et al. 1996), clavanin A (van Kan et al. 2003) and Amyloid β Protein (Lin et al. 2001). Membrane proteins such as aquaporins are preferably inserted into vesicles by other means. This can be done using the strategies for reconstitution of membrane proteins into vesicles as described for cytochrome c oxidase as a model protein in the introduction to chapter 4 on pages 41-45 of the herein incorporated thesis “Supported bilayers as models of biological membranes” by Danielle Keller, February 2005, MEMPHYS-center for biomembrane physics, Physics Department, University of Southern Denmark and Danish Polymer Centre, Risø National Laboratory, Denmark.

The present inventors have shown that the vesicle fusion method can be applied on a water-permeable dense surface, to create the novel membranes described herein.

Thus, according to another aspect of the invention there is provided a process for preparing the water membranes described herein, this process comprising:

a) mixing under aqueous conditions, one or more lipids with aquaporin proteins in the presence of a detergent in which these proteins are solubilized, such that the molar ratio of the lipids and the aquaporin proteins (LPR) ranges from 5000:1 to 50:1, as described before, to obtain a mixture.

Suitable detergents are described in Le Maire, M.; Champeil, P.; Møller, J. V., Interaction of membrane proteins and lipids with solubilizing detergents. Biochimica et Biophysica Acta (BBA)—Biomembranes 2000, 1508, (1-2), 86-111.

This mixture is mixed or shaken for a relatively short time, from a few seconds to a few hours, typically for about half an hour, although mixing for a longer period of time will do no harm and is simply not required.

b) Removing the detergent from the previously-obtained mixture to obtain a solution of lipid vesicles containing aquaporin proteins embedded in the lipids;

The detergent can be removed in any number of ways known in the art, including, but not limited to, molecular-sieve or gel-permeation resins (such as “Biobeads”), dialysis and more.

c) covering a water permeable dense support layer which is impermeable to the lipids and to the aquaporin proteins, in the solution, to obtain the water membrane.

The solution is used to cover the support membrane, such as NF membrane or RO membrane, and is left for “incubation” for a predetermined time ranging from a few minutes to a few hours, typically ranging from 1 to 2 hours.

An advantage of the present process for preparing the membrane is that, in contrast to presently known method of incorporating aquaporins in SPB on porous supports, the porous support has to be obtained by using a variety of sophisticated technologies (such as laser drilling on Teflon, radioactive irradiation on mica and similar methods), technologies which are limited in the amount they can handle. In contrast, the present process uses dense support membranes, such as NF/RO membranes, which are compatible with present day filtration technologies, and therefore the dense support membranes are available in unlimited supply.

As shown in the Examples section which follows, the membranes prepared as described herein showed high potential for being used in water filtration applications.

Thus, according to another aspect of the invention, there is provided a method for purifying water by filtration, comprising filtering an aqueous solution through the water membranes described herein, so as to retain ions, particles, organic matter and colloids, whereby the filtrate obtained by the filtration is water which is essentially free from ions, particles, organic matter and colloids.

The term “essentially free of” as used herein describes a situation whereby the concentration of the ions, particles, organic matter and colloids in the filtrate does not exceed 10% by weight of their concentration in the feed water. More preferably—only 1% by weight of their concentration in the feed water, and yet more preferably 0.1% of their concentration in the feed water.

Given the exceptional water-transport properties of the aquaporin proteins, and the resistance of the present membranes to high hydraulic pressures, these membranes may be used for a variety of high-performance water filtration uses, including in the high-tech industry (semi-conductor industry), in space-applications, in the pharmaceutical industry etc., this being in addition to typical water desalination, re-use and recycling application for irrigation, tap-water usage and similar uses.

Thus, according to another aspect of the present invention, there is provided the use of the water membranes described herein for water purification, water desalination, water recycling or water re-use.

Given the advantages described hereinabove, the water purification, water desalination, water recycling or water re-use are conducted at a zero-liquid-discharge mode.

The term “zero-liquid-discharge” refers to a closed system where no addition can be supplied, nor waste can be discharged; meaning a closed and totally recyclable system.

According to yet another aspect of the present invention, there is provided a nanofiltration (NF) water filtering device or a reverse-osmosis (RO) water filtering device for the production of desalinated water and/or or recycled water from a salt water source or from waste water, the desalinated water and/or the recycled water being useful for irrigation and/or as potable water, wherein the nanofiltration or reverse osmosis filtering device has at least one membrane(s) which has been replaced by the water membrane described herein.

Furthermore, there are provided a nanofiltration (NF) water filtering device or a reverse-osmosis (RO) water filtering device for the production of ultra-pure water from a crude water source, the ultra-pure water being useful in the semi-conductor industry and/or in the pharmaceutical industry, wherein the nanofiltration or reverse osmosis filtering device has at least one final membrane(s) which has been replaced by the water membranes described herein.

The term “ultra pure” water can be defined as having a resistivity of above 18.2 Mohm*cm at 25° C., and/or having a Total organic carbon (TOC) of less than 10 parts per billions (ppb).

### MATERIALS AND EXAMPLES

Lipids: 1,2-dimyristoyl-sn-glycero-3-phosphocholine (DMPC) was purchased from Sigma-Aldrich. 1,2-dimyrystoyl-3-trimethylammonium-propane (DMTAP) and 1,2-dimyristoyl-sn-glycero-phosphoethanolamine-N-(Lissamine-Rhodamine B Sulfonyl) (Ammonium salt), referred to as Rh-PE, were purchased from Avanti-Polar lipids.

NF membrane: flat sheet samples of NF270 membrane (Dow-Filmtec) and NTR7450 membrane (Hydranautics/Nitto Denko) were kindly supplied by the manufacturers. The top layer of NF270 is composed of polyamide and that of NTR is composed of sulfonated polyether-sulfone.

Lipid Solutions:

SMPC: 1.5 mM DMPC in an aqueous solution of 150 mM NaCl+20 mM MgCl₂+1 mM Tris HCl pH 7.8.

SMPCTAP: 1.5 mM DMPC+20 mol % DMTAP in aqueous solution containing 150 mM NaCl, 20 mM MgCl₂, 1 mM Tris (HCl) at pH 7.8.

SMPCTAP-Rh: same as SMPCTAP+0.5 mol % Rh-PE.

SNPCTAP: same as SMPCTAP, except the solvent is doubly distilled water (DDW).

SNPCTAP-Rh: same as SNPCTAP+0.5 mol % Rh-PE.

PM28 Aquaporin solution was received from Professor P. Kjellbom and Dr. U. Johanson from Lund University (Sweden) and contained: 10 mM Potassium Phosphate buffer (pH 7.5), 150 mM NaCl 10 vol % glycerol, 1 wt % Octyl glucoside (OG) and 8.41 mg/ml PM28 protein (extracted from spinach).

The aquaporin may be harvested in any required quantity from an engineered E. coli bacterial strain. It is estimated that about 2.5 mg of pure protein can be obtained from each liter of culture that is producing it, cf. US Patent Application No. 20040049230.

Proteoliposomes solution: SMPCTAP+20 μl aquaporin solution (Lipid-to-protein ratio (LPR)=3600)+1% wt OG. The solution was dialysed for 2 days using a 6-8 kDa molecular weight cutoff dialysis membrane (Spectra/Por) followed by extrusion through polycarbonate membrane with 100 nm diameter pores.

BioBeads is the commercial name for polystyrene porous beads produced by Bio-Rad.

pH was adjusted by 0.5 mM Tris (HCl) and the ionic strength was by 150 mM NaCl and 20 mM MgCl₂.

Force vs. Distance measurements: (force curves) were carried out using DNP-S (Veeco) cantilevers (spring constant 0.06 N/m). The vertical tip velocity was kept constant (1 μm/sec) during all measurements. Cantilever sensitivity was measured on freshly cleaved mica in DDW and the laser was kept in the same position during all measurements.

Phospholipids (PL) coverage on NF: NF270 (Dow) and NTR7450 membrane (Hydranautics/Nitto Denko) were sonicated in 50 vol % ethanol and 50 vol % DI water for 10 minutes to fully wet the pores and then washed for 5 minutes in DI water. Deposition of a PL layer was carried out by the vesicle fusion method on the NF membrane. 50 μl of the appropriate solution (the pH was adjusted by addition of HCl or NaOH) were used to cover 1 cm² of NF membrane for 3 hours, if not stated otherwise. Then the sample was gently rinsed with DDW.

Fluorescence images: all images were acquired using an Axio Imager A1M upright microscope (Zeiss) equipped with a filter set 20 (excitation 546/12 beam splitter 560 and emission 575-640 nm) and an AxioCam MRm microscope (Zeiss) using ×10 objective.

All images were taken using the same microscope and camera settings.

ATR-FTIR: performed on a Vertex 70 IR spectrometer (Bruker) equipped with a Miracle ATR attachment with a KRS-5 ATR window element protected with a diamond layer (Pike). This method was used for quantifying the amount of lipid in solutions as well as on the surface of a substrate. The spectra were recorded for solutions by covering the window with 50 μl of solution or, for supported lipid layers, by pressing a dry substrate with a deposited layer onto the window using a dedicated clamp. The results were analyzed using the QUANT 2 tool of the OPUS 6.5 software (Bruker) that uses a chemometric algorithm. The chemometric analysis showed a very good linear correlation with lipid amount (concentration or coverage) for samples used in calibration. In every experiment, if not stated otherwise, IR absorbance of bare element was used as background. The calibration for solutions was carried out by using 50 μl of lipid solution of known concentration for lipid layers on the surface of a NTR7450 membrane. Calibration employed several samples with known surface coverage prepared as follows: 1 ml of a lipid solution of known concentration was passed through an NF membrane of 25 mm diameter, the net area was 4.91 cm², using 10 bars of nitrogen as a driving force and lipid concentration in the permeate solution was determined as above. The quantity of lipid deposited per surface area on each calibration sample was then calculated considering the known quantity of lipid in the feed, in the permeate and the membrane area. To minimize interference from IR absorption by water during IR measurements, all the samples were dried at 40° C. in vacuum for 3 hours. Uniform distribution of fluorescently labeled lipids with Rh-PE on the samples surface was verified by fluorescence microscopy (see FIG. 1) and fairly uniform coverage was observed.

FRAP (Fluorescence recovery after photobleaching) measurements: 50 μl of SMPCTAP-Rh were used to cover freshly cleaved mica of 9.9 mm diameter for 30 minutes. Then, the mica was gently rinsed with DDW. For NTR7450, 50 μl of the SNPCTAP+Rh, adjusted to pH 2 with HCl, were used to cover a 1 cm² sample for 3 hours; then the sample was gently rinsed with DDW. For mica and NTR7450, a 561 nm laser beam was turned to full power to bleach the desired area. The required time for bleaching the sample was 9.3 seconds on mica and 32 seconds on NTR7450. All images were acquired on a confocal laser scanning microscopy (CLSM), LSM510 META microscope (Zeiss) with ×63 objective using the same pixel exposure time (1.27 μs). The excitation wavelength was set to 561 nm and emission intensity was read in the range 593-604 nm, characteristic of Rhodamine B. The bleached area was a 308 μm² circle on all samples.

Flux measurements: were carried out using a filtration cell of dead-end configuration with a thermal jacket, without stirring at 30° C. The sample had a net filtration area of 3.46 cm² (21 mm diameter). Prior to measurements, the sample of NTR7450 was sonicated in 50% (vol.) ethanol for 10 minutes to fully wet the pores, and washed in DI water for 5 minutes. First, the pure water flux and hydraulic permeability of clean NTR7450 were measured at a pressure of 10 bars. Then the cell was filled with SNPCTAP solution at pH 2 (same as in the AFM section) and 3 hours were allowed for vesicle fusion. Thereafter the dissolved lipids were removed, while keeping the membrane always wet. This was achieved by carefully sucking off 90% of the liquid in the cell and refilling it with DI water, repeated five times. After this repeated dilution the residual amount of lipid in the solution left in the cell was smaller by orders of magnitude than the estimated amount of lipid covering the NF surface, assuming formation of a SPB. The cell was then filled with DDW and pressurized to 10 bars (145 psi) using nitrogen to measure the flux and calculate the hydraulic permeability. 10 minutes were allowed for stabilization after pressurizing the cell and then the flux was measured by continuously collecting and weighing the permeate vs. time for 5 minutes using an analytical balance.

ATR-FTIR Spectroscopy (for determining the amount of deposited phospholipid)

ATR-FTIR was calibrated to predict concentration of DMPC on NTR7450 in mol×cm⁻² unit. In order to convert mol×cm⁻² units to the number of equivalent bilayers, the average area 0.7 nm²×lipid⁻¹ for the DMPC lipid was assumed, which yields 4.75×10⁻¹⁰ mol×cm⁻² per equivalent bilayer.

### Example 1

### Phospholipids Bilayer Formation on NTR7450 Membrane (Solution A)

Solution A was prepared as follows: mixture of 1,2-dimyristoyl-sn-glycero-3-phosphocholine (DMPC, 0.015 grams), 1,2-dimyrystoyl-3-trimethylammonium-propane (DMTAP 0.003 grams) and 1,2-dimyristoyl-sn-glycero-phosphoethanolamine-N-(Lissamine-Rhodamine B Sulfonyl 3×10⁻⁴ grams) which will be referred as Rh-PE were dissolved in chloroform (1 ml) and shaken for 1 minute. The last lipid (i.e. Rh-PE) was added when fluorescence probe is required. The chloroform was evaporated at 40° C. under vacuum for 2 hours. The mixed lipids were introduced into aqueous solution (pH 2-8 with as low as possible ionic strength) to give final concentration of 1.5 mM DMPC+20% mol DMTAP+0.5% mol Rh-PE (solution A).

Solution A was shaken for 1 hour at 40° C. and was extruded through a polycarbonate membrane having 100 nm pores 10 times at 30° C. A piece of the NTR7450 membrane was covered by solution A for 3 hours (for pH 2) and washed with DDW.

The coverage of NF membrane by lipids was optimized by calibrating the pH of the lipids solution and keeping the ionic strength as low as possible. In order to assess the coverage qualitatively, 0.5 mol % of Rh-PE was added to the lipids solution and fluorescence images were acquired. The best coverage was achieved at pH 2 on NTR7450, as clearly shown in fluorescence microscopy images taken before and after this procedure (FIG. 1).

### Example 2

### Phospholipids Bilayer Formation on NTR7450/NF 270 Membranes

The procedure described in example 1 was repeated except that solution A was left over the NTR7450 membrane for 30 minutes and then the sample was washed by DDW. The sample was scanned using AFM at different times. The topography images can be seen in FIG. 2.

The same procedure was carried out on the NF270 membrane; no topography changes were recognized.

### Example 3

### Characterization of the Phospholipids Bilayers Formed on NTR7450/NF720 Membranes

The procedure described in example 1 was repeated and then the sample was rinsed with DDW.

The formed bilayers were characterized by fluorescence microscopy, Fluorescence Recovery after Photobleaching (FRAP) using Confocal Laser Scanning Microscopy (CLSM), Atomic Force Microscopy (AFM), Attenuated Total Reflection Fourier Transform IR (ATR-FTIR) and water flux.

All measurements showed good coverage of the bilayer on the surface with regions of double bilayer formation.

Hydraulic Permeability Measurements of clean NTR7450 and NTR7450 after 3 hours of vesicle fusion are presented in FIG. 3 below (whereas symbols are experimental data, lines are linear fits), resulting in 10.3 L×m⁻²×hr⁻¹×bar⁻¹ for clean NTR7450 and 0.3 L×m⁻²×hr⁻¹×bar⁻¹ for NTR7450 after 3 hours of vesicle fusion. This means that, using resistances in series (1/Lp) additively, the permeability of the lipid layer is (1/0.3−1/10.3)⁻¹=0.31 L×m⁻²×hr⁻¹×bar⁻¹.

The same procedure was carried out on the NF270 membrane using solution A and no hydraulic permeability change was measured compared to NF270 before the executing the procedure.

Stable water flux in filtration experiments also seems to indicate that the phospholipid layer withstood the hydraulic pressure and was not damaged by the flow and pressure gradient. Though no surface characterizations were performed after the flux measurements, the phospholipid layer integrity is indirectly confirmed by results of repeated flux measurements on the same sample that showed no change in the flux.

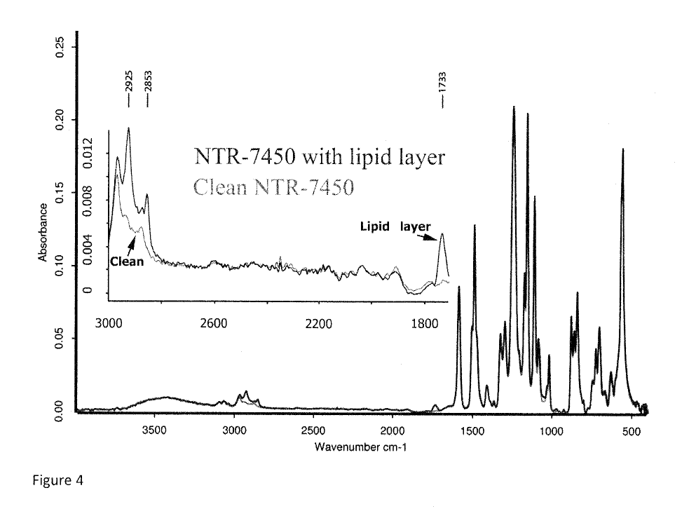

The ATR-FTIR spectra of clean NTR7450 (bright line) and NTR7450 covered with lipids (darker line) is presented in FIG. 4, whereas the larger plot shows the full measured spectra and the smaller plot focuses on the bands that can be assigned to the lipids.

### Example 4

### Aquaporins Incorporation (Solution B)

In order to incorporate aquaporins using the vesicle fusion technique, the aquaporins have to be incorporated in the vesicle solution stage. This was done by detergent-mediated reconstitution technique which is described in details elsewhere (Detergent Removal by non Polar Polystrene Beads. J. L Rigaud, D. Levy, G. Mosser, O. Lambert. 27, 1998, Eur Piophys J, pp. 305-319). In brief, a mixture of lipids, detergent and proteins was introduced into the aqueous solution and the solution was shaken for a pre-determined time. Then the detergent was selectively removed using BioBeads or by dialysis, and the proteins (e.g. aquaporins) were spontaneously incorporated in the formed vesicles.

150 μl of solution A (at neutral pH only), 50 μl of 20% wt Triton X-100 in DDW solution and 20 μl of aquaporin solution were shaken for 30 minutes at room temperature.

200 mg of freshly rinsed BioBeads were introduced into the solution and the solution was shaken for 2 hours, thereby producing solution B.

NTR7450 membrane was covered by solution B for 3 hours.

### Example 5

### Water Permeability Results of Membranes with and without Aquaporin Coverage

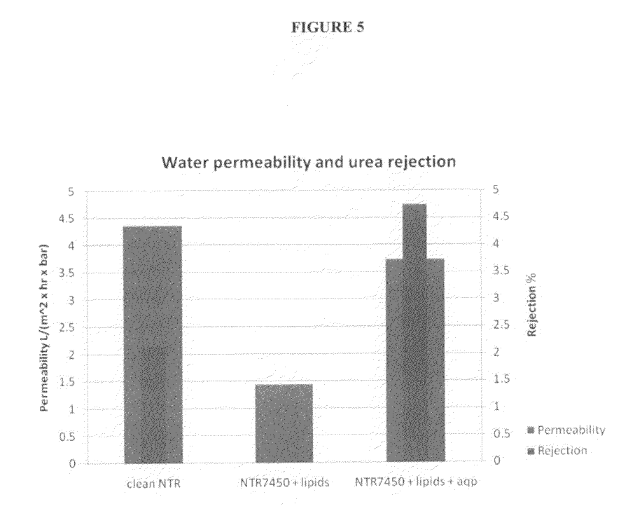

In order to study how the SPB coverage affects the water permeability and the urea rejection, the permeability of clean NTR7450 was measured. Then SPB with embedded aquaporins or without was prepared on that membrane and water permeability and urea rejection were measured. The results are summarized in FIG. 5.

The flux of NTR7450+lipids was lower than the permeability of clean NTR7450, though the permeability is about 1-2 orders of magnitude higher than expected from lipid's bilayer permeability. The addition of aquaporins increased the water permeability compared to coverage without aquaporins. The urea rejection of clean NTR7450 was lower than the membrane with lipid and aquaporins coverage.

1. A water membrane comprising a lipid bilayer supported on a single side thereof on a water permeable dense support layer, wherein
said lipid bilayer is composed of one or more lipids, wherein aquaporin proteins are embedded in said one or more lipids,
and further wherein said water permeable dense support layer is impermeable to said one or more lipids and to said aquaporin proteins.

2. The membrane of claim 1, wherein said dense support layer is composed of a dense polymeric substrate.

3. The membrane of claim 2, wherein said dense polymeric substrate is a nano-filtration (NF) membrane or reverse osmosis (RO) membrane.

4. The membrane of claim 3, wherein said nano-filtration (NF) membrane or said reverse osmosis (RO) membrane is composed of a polymer which is selected from: polyamide, polyether, polyester, polysulfone, polyethersulfones, sulfonated polyethersulfones, polyvinylalcohol, poly(ethylene glycole), poly(propylene glycole), polyurea, polyurethane, polydimethylsiloxane, polyimide, polyphenylenoxide, polyanyline, polypyrrole, polythiophene, poly(amic acid), polyacrylic acid, polyacrylamide, polyacrylonitrile, polystyrene, polybenzimidazole, polyamine, poly(ethylene imine), their sulfonated, carboxylated, PEGylated or derivatives thereof.

5. The membrane of claim 1, wherein said lipid bilayer is a phospholipid bilayer.

6. The membrane of claim 5, wherein said phospholipid bilayer essentially consists of one or more phospholipids selected from the group consisting of 1,2-dimyristoyl-sn-glycero-3-phosphocholine (DMPC), 1,2-dimyrystoyl-3-trimethylammonium-propane (DMTAP), 1,2-dimyristoyl-sn-glycero-phosphoethanolamine-N-(Lissamine-Rhodamine B Sulfonyl) (Ammonium salt), phosphoglycerides, sphingolipids, cardiolipin, cholesterol, synthetic lipids and/or mixtures thereof.

7. The membrane of claim 1, wherein the molar ratio of said lipids to said aquaporin proteins (LPR) in said lipid bilayer ranges from 5000:1 to 50:1.

8. The membrane of claim 1, wherein said membrane withstands hydraulic pressures of at least 290 psi.

9. A process for preparing the water membrane of claim 1, said process comprising:
a) Mixing, under aqueous conditions, one or more lipids with aquaporin proteins in the presence of a detergent in which said proteins are solubilized, wherein the molar ratio of said one or more lipids to said aquaporin proteins (LPR) ranges from 5000:1 to 50:1, to obtain a mixture;
b) Removing said detergent from said mixture to obtain a solution of lipid vesicles containing aquaporin proteins embedded in said lipids;
c) covering a water permeable dense support layer which is impermeable to said lipids and to said aquaporin proteins, in said solution, to obtain said water membrane.

10. The process of claim 9, wherein said lipid bilayer is a phospholipid bilayer.

11. A method for purifying water by filtration, comprising filtering an aqueous solution through the water membrane of claim 1, so as to retain ions, particles, organic matter and colloids, whereby the filtrate obtained by said filtration is water which is essentially free from ions, particles, organic matter and colloids.

12. The use of the water membranes of claim 1 for water purification, water desalination, water recycling or water re-use.

13. The use of claim 13, wherein said water purification, water desalination, water recycling or water re-use is conducted at a zero-liquid-discharge mode.

14. A nanofiltration (NF) water filtering device or a reverse-osmosis (RO) water filtering device for the production of desalinated water and/or or recycled water from a salt water source or from waste water, said desalinated water and/or said recycled water being useful for irrigation and/or as potable water, wherein said nanofiltration or reverse osmosis filtering device has at least one membrane(s) which has been replaced by the water membrane of claim 1.

15. A nanofiltration (NF) water filtering device or a reverse-osmosis (RO) water filtering device for the production of ultra-pure water from a crude water source, said ultra-pure water being useful in the semi-conductor industry and/or in the pharmaceutical industry, wherein said nanofiltration or reverse osmosis filtering device has at least one membrane(s) which has been replaced by the water membrane of claim 1.
